(19) United States
(12) Patent Application Publication
(10) Pub. No.: US 2015/0039124 A1
(43) Pub. Date: Feb. 5, 2015

(54) Automatic Medication Compliance Dispenser System And Method

(71) Applicants: Ronald Justin Mistovich, Pittsburgh, PA (US); Patrick Daniel Kichinosuke Miller, Pittsburgh, PA (US)

(72) Inventors: Ronald Justin Mistovich, Pittsburgh, PA (US); Patrick Daniel Kichinosuke Miller, Pittsburgh, PA (US)

(21) Appl. No.: 13/954,488

(22) Filed: Jul. 30, 2013

(51) Int. Cl. G06F 19/00; G07F 11/00; G07F 17/00; A61J 7/04; G07F 11/16

(52) U.S. Cl. CPC G06F 19/3462; A61J 7/0481; G07F 11/16; G07F 17/0092; G07F 11/005
USPC 700/237; 221/13

(57) ABSTRACT

An automatic medication dispensing device for dispensing medication to a patient including a medication dispensing unit having at least one tablet dispensing cartridge for receiving and retaining a plurality of tablets. The cartridge is electronically controlled by a computer system configured to receive a signal and activate the cartridge to dispense a tablet. The cartridge has a tablet receiving space for receiving and retaining a plurality of tablets in a vertical stack and a tablet dispensing opening to allow for at least one tablet to be dispensed from the cartridge. A moveable ram is associated with the cartridge to engage a single tablet in the vertical stack and expel the single tablet from the cartridge.

### FIELD OF THE INVENTION

This invention relates to an automatic medication compliance dispenser for dispensing medication to a patient and monitoring and logging patient compliance.

### BACKGROUND OF THE INVENTION

In order for effective treatment of patients using medication it is important that the patient takes the medication timely and in the amounts prescribed. It is difficult for doctors to determine if the medication regimen that they prescribed is effective if the patient fails to follow the required timing, dosage and frequency requirements. For example, elderly patients may be unable to remember when they need to take their medication or when they last took it. When several medications are required at different times of day and at different frequencies, it is even harder for a patient to maintain the proper scheduling.

Additionally certain classes of medication, such as painkillers, are subject to abuse and even theft. Many times these medications are prescribed in limited amounts so it is also important that prescriptions be refilled timely to maintain the regimen.

### OBJECTS AND SUMMARY OF THE INVENTION

It is an object of the invention to provide a computerized medication dispensing device;

Another object of the invention is to provide a dispensing device having an electro-mechanical mechanism for dispensing individual units of medication;

Still another object of the invention is to provide an alarm to a patient telling when to take their medication;

Yet another object of the invention is to provide a computer system that can track and report a patient's adherence to a prescribed regimen;

Still another object of the invention is to provide a dispenser having a medication containing cartridge that is refillable;

Yet another object of the invention is to provide a dispenser that is capable of having a plurality of cartridges;

Still another object of the invention is to provide a cartridge that is adjustable for retaining units of medication having different sizes; and

Yet another object of the invention is to provide a computer system that can report when refill of the medication are due.

In summary, the invention is directed to an automatic medication dispensing device for dispensing medication to a patient comprising a medication dispensing unit having at least one tablet dispensing cartridge for receiving and retaining a plurality of tablets and the cartridge being electronically controlled by a computer system configured to receive a signal and activate the cartridge to dispense a tablet and the cartridge having a tablet receiving space for receiving and retaining a plurality of tablets in a vertical stack and the cartridge having a tablet dispensing opening to allow for at least one tablet to be dispensed from the cartridge and a moveable ram associated with the cartridge to engage a single tablet in the vertical stack and expel the single tablet from the cartridge.

The invention is further directed to a system of dispensing medication using a computer controlled dispensing device, comprising a computer having a program designed to operate a dispensing device and a dispensing device having at least one cartridge for containing medication and the dispensing device having an electrically operated mechanism for extracting medication from said cartridge for delivery to a patient and a personal notification unit adapted to be carried by a patient and the personal notification device having a signaling apparatus for providing an alarm to the patient to indicate when a dose of medication is required the computer being programmable to schedule when medication is required to be taken by the patient the computer being operable to send a signal to the personal notification device so that the notification device will provide an alarm to the patient and the computer being in communication with the dispensing device and the dispensing device including a proximity sensor for determining when the personal notification device is near the dispensing device and the computer further being programmable to cause the dispensing device to dispense medication when the personal notification device is in the proximity of the dispensing device.

The invention further being directed to a method for dispensing medication to a patient using a computer controlled dispensing device, comprising the steps of programming a dispensing device to dispense medication to a patient according to a schedule having a predetermined frequency, time and amount and retaining a plurality of units of medication in a dispensing device and determining the proximity of a patient to the dispensing device and, dispensing at least one unit of medication to the patient according to the schedule when the patient is in the proximity of the dispensing device.

### BRIEF DESCRIPTION OF THE DRAWINGS

FIG. 1 is a schematic view of the automatic medication dispenser system;

FIG. 2 is a schematic view of the calendar and web-based medication dispenser mechanism;

FIG. 3 is perspective view of a medication dispenser base station;

FIG. 4 is a partially exploded view of the medication dispenser cartridge;

FIG. 5 is a cross-sectional view of the medication dispenser cartridge of FIG. 4;

FIG. 6 is a cross-sectional view of the cartridge of FIG. 5 taken along lines 6-6;

FIG. 7 is a cross-sectional view showing the adjustment mechanism;

FIG. 8 is another of the adjustment mechanism;

FIG. 9 is a schematic view illustrating the use of the system;

FIG. 10 is a perspective view of a wristband;

FIG. 11 is a perspective view of an alternative embodiment showing a modular cartridge system;

FIG. 12 is a perspective view of an alternative embodiment showing a liquid dispensing cartridge; and

FIG. 13 is a perspective view of the liquid plunger system.

### DETAILED DESCRIPTION OF THE INVENTION

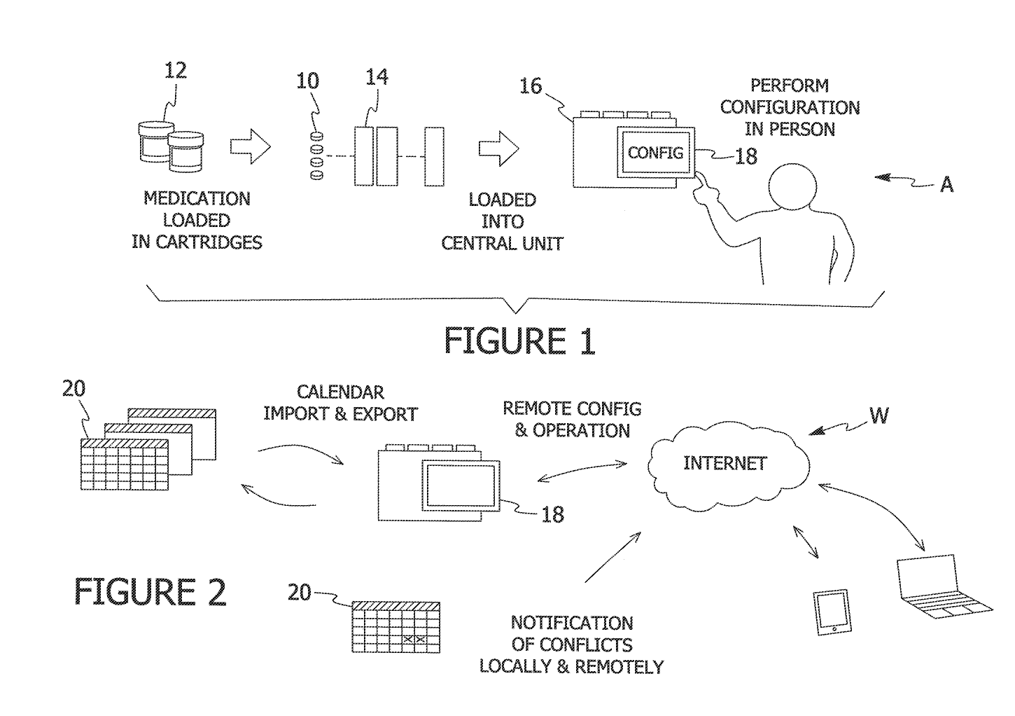

As shown in the schematic drawing of FIG. 1, the preferred embodiment of an automatic medication compliance dispenser system A is shown for automatically dispensing pill-based medication and monitoring and logging medication compliance and performing user notification and scheduling to assist in compliance. The system A includes loading medication 10 such as tablets, for example, from a filled prescription container 12, into a cartridge 14.

While tablets 10 are shown for illustrative purposes, those skilled in the art should understand that capsules or individually sealed packets and the like would also be useable. Preferably, the cartridge 14 is associated with a base station 16 which can be programmed to operate the cartridge 14 to dispense the medication 10. The base station 16 uses software that sets a schedule for the medication 10. The base station 16 includes an interface 18 which may be a touch screen or a keyboard that facilitates entry into the system the schedule, i.e. the frequency, time and amount of medication 10. As shown in FIG. 2, the interface 18 can display a calendar 20 from which a date can be selected and then the calendar 20 can be consulted to check when a refill of medication 10 is coming due or when the next medical appointment is scheduled. When the base station 16 is first configured for a cartridge 14, the parameters for the medication 10 is entered and stored on the calendar 20. The system A allows for the manual or automatic integration of the user's schedule. If their schedule conflicts with a medication disbursement time, an alert is sent to the user or caregiver. If desired, the system A can dispense additional medication early for the user to have if away from the system during the dosing time. The system can be set to send an alert via phone, sms, email or other electronic method to the user and/or the caregiver at the appropriate medication dosing time.

It is also envisioned that the system can be configured through a web-based server W if desired. The web-based server W can also be used to check for medication conflicts.

To promote medication compliance, the dispenser system A tracks compliance and provides rewards to the patient in the form of positive messages, animations, or virtual trophies for reaching predetermined compliance goals (e.g. not missing a dose for a week). This information would be shared with the patient's physician so that compliance can be monitored. By sharing this information with the physician, informed medical decision making can occur on a previously unattainable level with respect to treatment efficacy, dosing parameters, and patient compliance. For example, the patient's response to treatment can be determined based on whether the patient is taking the medication at the proper times, not missing doses and then it can be determined whether the dosage should be increased or decreased, or did the patient take the medication the day that the patient was seen by the physician. The compliance information may also be shared with the patient's consent to the patient's insurance company which may lead to lower insurance premiums or discounts.

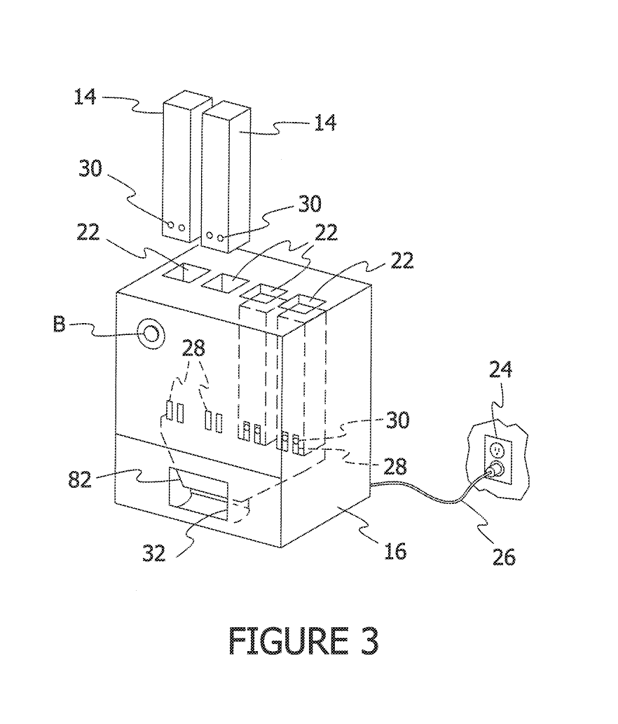

FIG. 3 illustrates a first preferred embodiment of the base station 16 having a plurality of slots 22 sized to receive cartridges 14. The base station 16 is provided with a power source 24 such as an electric cord 26 extending to a conventional electrical outlet (not shown) or the base station may be battery powered. Inside each of the slots 22 is an electrical contact 28. Each cartridge 14 includes electrical contacts 30 which engage the base station electrical contact 28 to supply power to the cartridge 14 and to provide a signal to operate the cartridge 14 to dispense a dose of medication through opening 32. Tablets 10 are preferably loaded into cartridges 14 by either the patient or the caregiver and the cartridges 14 may need to be reloaded with tablets 10 every month. In order to open the base station 16 to load tablets 10, the user/caregiver will have to push the LOAD button B and enter an access code. Depending on the independence of the caregiver, this code can be known by only the caregiver, only the patient, or both patient and caregiver to allow security of remaining tablets 10. Some tablets 10 that patients may take multiple times daily, and multiple tablets 10, may require two cartridges 14 with the same tablet 10. The system A must recognize that these tablets 10 are the same and know to dispense one cartridge 14 until empty, and then dispense from the second cartridge 14.

When a cartridge 14 is locked into place, the touch display screen will prompt the user to enter medication information including a name, tablet size, i.e. 800 mg, dosage i.e. 1 tablet, as needed or scheduled? User will either check one, or if as needed, the user will check a separate dialog of what it is needed for, e.g. pain and how often, i.e. twice daily, and the quantity loaded in cartridges 14, i.e. 90. If two cartridges 14 are entered with the same name of tablet, the system will ask “Is this a second cartridge with the same medication previously entered for the month?”

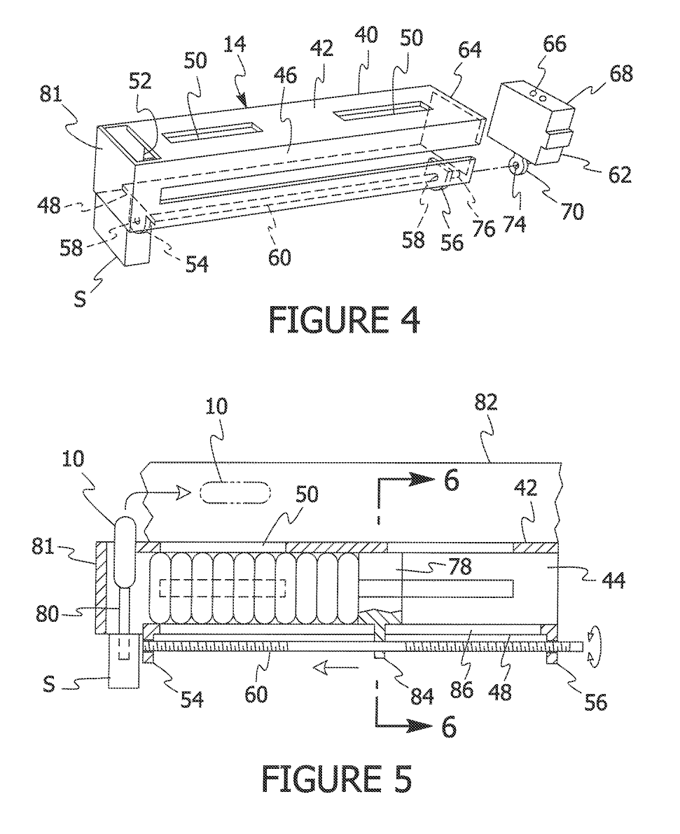

Now the cartridge 14 will be described in detail with respect to FIGS. 4 through 8. As shown in FIG. 4, the cartridge 14 includes an elongated, hollow housing 40, generally rectangular or square in cross-section having a front wall 42, a back wall 44, a first side wall 46 and a second side wall 48. Front wall 42 and first side wall 46 preferably each have a slot 50 and 52, respectively extending substantially the length of each of walls 42 and 46, but not the entire length so that a portion of the walls 42 and 46 are structurally connected. Back wall 44 includes a pair of flanges 54 and 56 extending substantially perpendicularly. Each of flanges 54 and 56 include an opening 58 for receipt of a threaded rod 60. Flanges 54 and 56 act as braces to retain the threaded rod 60 in its proper location. A portion of rod 60 extends beyond flange 56 to engage the drive motor 62 located at the bottom 64 of the cartridge 14. Drive motor 62 is electrically powered and operates to turn the threaded rod 60 in response to a signal from the base station 16. Drive motor 62 includes electrical contacts 66 which engage electrical contacts 28 in the slots 22 of the base station 16. Drive motor 62 includes an outer housing 68 sized to slide into the bottom 64 of cartridge 14. A rotor 70 extends outwardly from the housing 68 and includes an opening 74 for receiving an end 76 of the rod 60. The rotor 70 turns the rod 60 in response to a signal from the base station 16. A driver or ram 78 is threadably connected to the threaded rod 60 and moves upwardly from the driver motor housing 68 when the threaded rod 60 is rotated in one direction and the driver 78 moves downwardly when the threaded rod 60 is rotated in the opposite direction.

As shown in FIG. 5, back wall 44 includes an pin 80 operated preferably by a solenoid S, wherein the pin 80 acts to engage a tablet or packet as it is driven upwardly and guide the tablet to the front of the cartridge 14 so that the tablet 10 will spill through the opening C and over the front wall 42 of the cartridge 14 and fall into an internal chute 82 in the base station 16 and then drop to the opening 32 as shown in FIG. 3. The top 81 of the cartridge 14 is formed of a moving or floating cap. Since tablets 10 can be of different thicknesses, the opening C through which the tablet 10 is pushed out needs to be adjustable. To accommodate the different tablet sizes, the top 81 and the pin 80 can raise or lower. The pin 80 moves at one half the height of the opening C as the opening C is increased so that the pin 80 is always at the middle of the opening C to engage the middle of the tablet 10 and push the tablet 10 out of the opening C. When tablets 10 are added to the cartridge 14, the height of each tablet 10 is derived from one of two methods. First, if the cartridge 14 is a non-adjustable cartridge 14, as in a cartridge 14 that is pre-filled with a known brand of tablet 10, the height of the tablet 10 is known because that cartridge 14 is only used with a certain brand of tablet 10. On the other hand, when the cartridge 14 is adjustable, the system asks how many tablets 10 have been loaded and then based on the number of tablets 10 that have been loaded into the cartridge 14 and the position that the tablet advancing mechanism is at when it makes contact with the tablet 10, the height of each tablet 10 can be derived. Once the height of the tablet 10 is determined, the adjustment of the height of the pin 10 and the sized of the opening C are automatically adjusted by the movement of the driver 78. The solenoid S can be either wired to the cartridge 14 and controlled by the base station 16 or can be controlled wirelessly by the base station 16 using conventional wireless techniques.

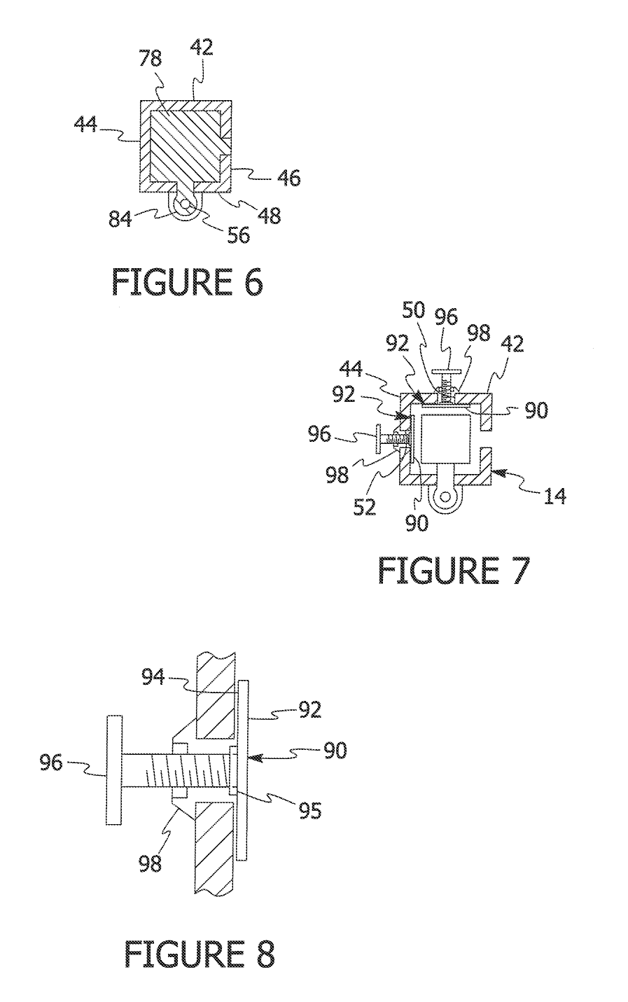

A cross-sectional view of the driver 78 is shown in FIGS. 5 and 6. The driver 78 is shaped to fit inside the walls 42, 44, 46 and 48 of the cartridge 14 and includes a rod 60 engaging internally threaded tab 84 which extends through slot 86 on the back wall 44 of the cartridge 14.

As shown in FIGS. 7 and 8, the cartridge 14 preferably includes two moveable plates 90 for adjusting the internal size of the cartridge 14. Plates 90 include a smooth front 92 for contacting the tablets within the cartridge 14 and a back 94 having a cup 95 for rotatably engaging an adjustment screw 96. An adjustment screw retainer 98 having internal threads 100 retains the adjustment screw 96 in the slot 50 of front wall 42 and similarly a second adjustment screw retainer 98 retains an adjustment screw 96 in the slot 52 of side wall 44. As the adjustment screws 96 are rotated, the plates 90 can be moved into the hollow housing 40 to reduce the cross-sectional area of the hollow housing 40 so that tablets can remain stacked. It is important that the tablets remain stacked so that only one tablet will be extracted from the cartridge 14 at a time.

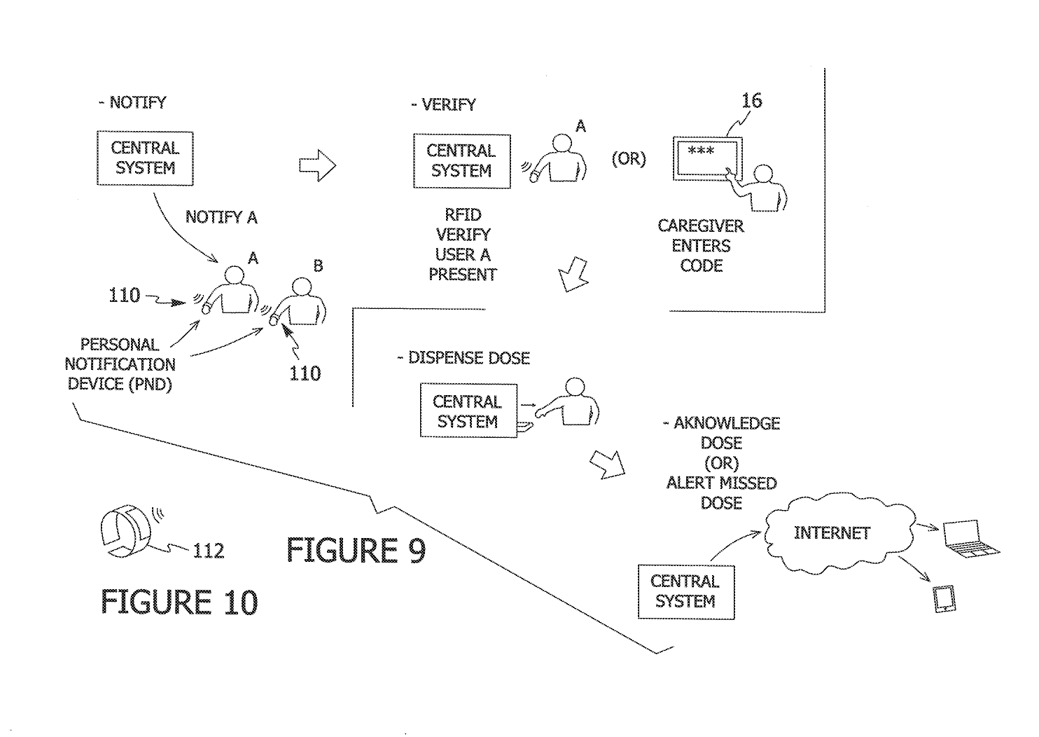

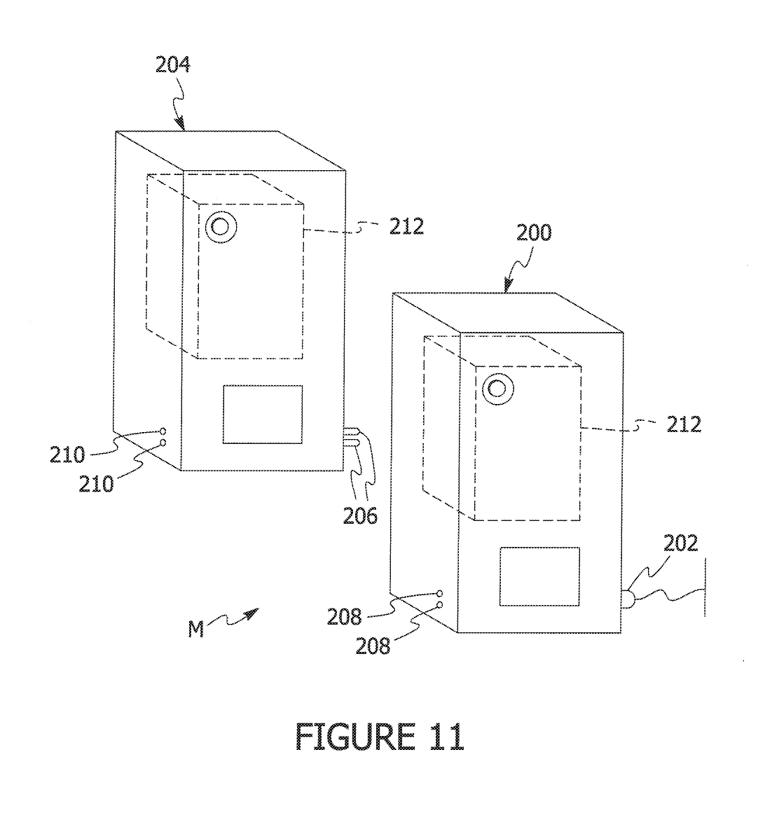

Now with reference to FIGS. 9 and 10 a preferred form of operation of the system will be described. After the system has been loaded with medication and programmed to dispense medication according to a prescription, the base station 16 will send a signal to a patient or caregiver and cause a personal notification device 110 to provide an indication that the time for taking medication has arrived. This notification may be a beeper or buzzer or vibration or both. The personal notification device 110 may be an object held in a pocket or may be in the form of a wristband 112 as shown in FIG. 10. In either case, the personal notification device 110 need only be large enough to contain a power source such as a battery, an antenna to receive a signal such a radio signal or Bluetooth wireless signal and needs to also contain hardware for analyzing the signal and mechanical hardware to produce a vibration or sound to provide notification to the patient or caregiver.

Upon sending and receipt of the signal to take medication, the patient needs to verify their presence near the dispenser. Optionally, the caregiver may enter a code to indicate their presence. The patient may indicate their presence by being near to the base station 16. The base station 16 preferably includes a presence detecting software that can detect when the personal notification device 110 is in the vicinity of the base station 16. Upon verification of the presence of the patient, the dose of medication is dispensed. Preferably the patient then acknowledges the dispensing of the medication presumably takes the medication as prescribed and the system records that the patient has complied with the prescription. If the patient does not move to the vicinity of the base station 16 so that the dose of medication is dispensed or does not verify receipt of the medication, the system can record an alert that the dosage was missed. The alert can be sent via the internet to the doctor's office and recorded in the patient's record.

An alternative embodiment of the invention is depicted in FIG. 11 showing a modular apparatus M having a base cartridge 200 which may be connected to a computer by a USB port 202 or a radio signal or Bluetooth signal. The base cartridge 200 may be powered by a battery or a conventional power cord or preferably power through a USB connection. The cartridge 200 includes a motor and drive mechanism as previously described in connection with the preferred embodiment. In this embodiment, the instructions for operating the cartridge 200 can be contained in a separate computer or the cartridge 200 itself may contain a programmable module having software for accepting instructions pertaining to the patient, dosage requirements and timing. Additionally, separate cartridges 204 may be connected to the base cartridge 200 by plugging the electrical connectors 206 of cartridge 204 into the electrical connectors 208 of base cartridge 200. Similarly, cartridge 204 includes an electrical connector 210 so that additional cartridges may be connected in series. Each of the cartridges 200 and 204 includes a tablet receiving space 212 and the drive mechanism as described in the preferred embodiment.

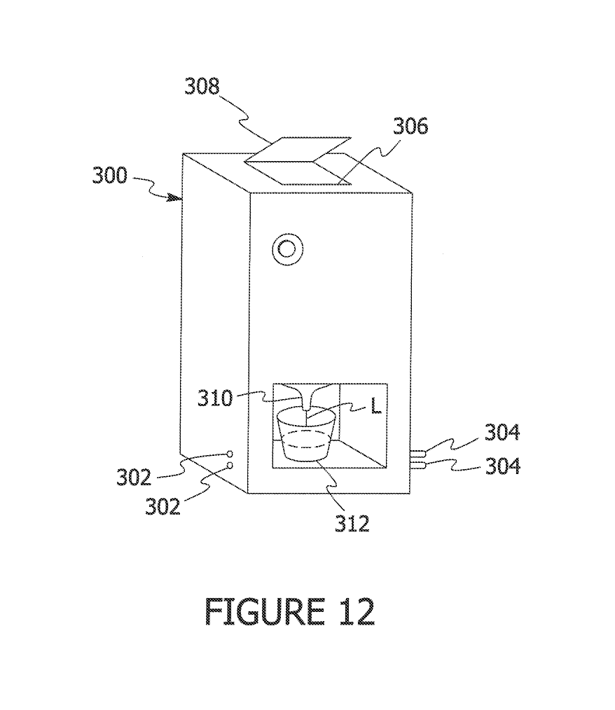

FIG. 12 illustrates a liquid dispensing cartridge 300 having electrical connectors 302 and 304 for use with the modular system M as described with respect to FIG. 11. Cartridge 300 includes a liquid medication reservoir 306 accessed by cap 308. Liquid medication L is dispensed from a spout 310 into a cup 312.

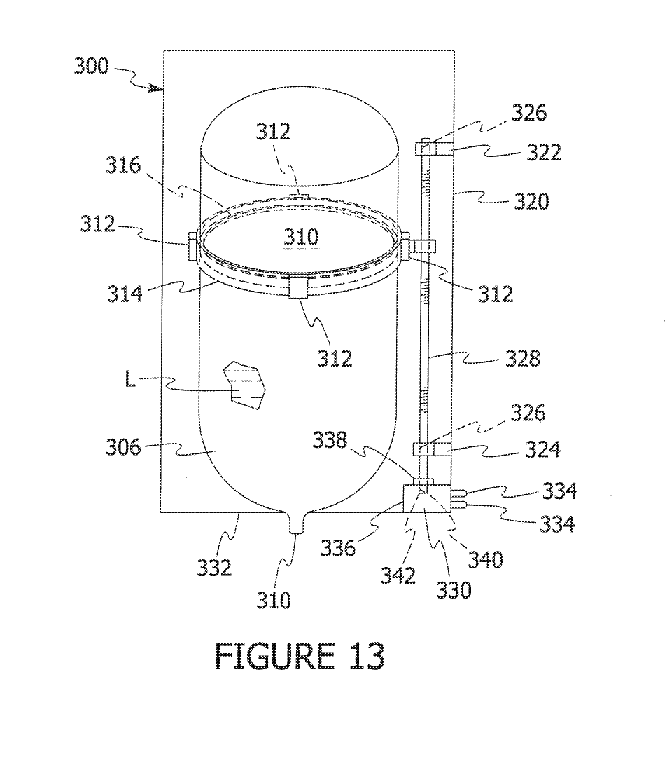

The liquid dispensing cartridge 300 is a sealed plunger system. As shown in FIG. 13, the liquid reservoir 306 located inside of cartridge 300 and includes a magnetic plunger 310 which rides on top of the liquid L and magnets 312 carried on a ring 314 on the outside of the liquid reservoir 306 are moveable downward and cause the plunger 310 to move downwardly to dispense the liquid L.

The plunger 310 is formed of an iron containing metal and includes an elastic seal 316 which engages the interior of the reservoir 306 to form an air tight seal to prevent so that a vacuum is formed to prevent the liquid L from flowing from the spout 310 through gravity. The ring 314 is moveable by a similar mechanism as described with respect to FIGS. 4 and 5.

The outer wall 320 includes a pair of flanges 322 and 324 extending substantially perpendicularly. Each of flanges 322 and 324 include an opening 326 for receipt of a threaded rod 328. Flanges 322 and 324 act as braces to retain the threaded rod 328 in its proper location. A portion of rod 328 extends beyond flange 324 to engage the drive motor 330 located at the bottom 332 of the cartridge 300. Drive motor 330 is electrically powered and operates to turn the threaded rod 328 in response to a signal from the base station 16. Drive motor 330 includes electrical contacts 334 which engage electrical contacts 28 in the slots 22 of the base station 16. Drive motor 330 includes an outer housing 336 sized to slide into the bottom 332 of cartridge 300. A rotor 338 extends outwardly from the housing 336 and includes an opening 340 for receiving an end 342 of the rod 328. The rotor 338 turns the rod 328 in response to a signal from the base station 16. The magnetic ring 314 is threadably connected to the threaded rod 328 and moves downwardly from the driver motor housing 336 when the threaded rod 328 is rotated in one direction and the ring 314 moves downwardly when the threaded rod 328 is rotated in the opposite direction.

While this invention has been described as having a preferred design, it is understood that the invention is capable of further modifications, uses and/or adaptations following in general the principle of the invention and including such departures from the present disclosure as come within the known or customary practice in the art to which it pertains and as may be applied to the central features hereinbefore set forth, and fall within the scope of the invention or the limits of the claims appended hereto.

We claim:

1. An automatic medication dispensing device for dispensing medication to a patient comprising:
a) a medication dispensing unit having at least one tablet dispensing cartridge for receiving and retaining a plurality of tablets;
b) said cartridge being electronically controlled by a computer system configured to receive a signal and activate the cartridge to dispense a tablet;
c) said cartridge having a tablet receiving space for receiving and retaining a plurality of tablets in a vertical stack;
d) said cartridge having a tablet dispensing opening to allow for at least one tablet to be dispensed from the cartridge; and,
e) a moveable ram associated with the cartridge to engage a single tablet in the vertical stack and expel the single tablet from the cartridge.

2. The dispensing device as set forth in claim 1, wherein:
a) the cartridge is elongated vertically to retain a stack of tablets.

3. The dispensing device as set forth in claim 1, wherein:
a) the cartridge forms a vertically elongated box having four walls defining the tablet receiving space;
b) a first wall of said four walls having a first moveable plate adjacent thereto and extending substantially the length of the first wall and extending substantially the length of the first wall;
c) a second wall of said four walls extending perpendicularly to said first wall and having a second moveable plate adjacent thereto and extending substantially the length of the second wall;
d) said first moveable plate having an adjustment device connected thereto for moving the first moveable plate away from said first wall;
e) said second moveable plate having an adjustment device connected thereto for moving the second moveable plate away from said second wall;
f) whereby, the first and second moveable plates can be adjusted so that the tablet receiving space can conform to tablets having different shapes.

4. The dispensing device as set forth in claim 3, wherein:
a) the adjustment device includes a threaded screw mechanism for positioning the first and second moveable plates.

5. The dispensing device as set forth in claim 1, further comprising:
a) a plurality of cartridges.

6. The dispensing device as set forth in claim 5, wherein:
a) each of said plurality of cartridges can be configured to contain a different sized tablet than the other of said plurality of cartridges.

7. A system of dispensing medication using a computer controlled dispensing device, comprising:
a) a computer having a program designed to operate a dispensing device;
b) a dispensing device having at least one cartridge for containing medication;
c) said dispensing device having an electrically operated mechanism for extracting medication from said cartridge for delivery to a patient;
d) a personal notification unit adapted to be carried by a patient;
e) said personal notification device having a signaling apparatus for providing an alarm to the patient to indicate when a dose of medication is required;
f) said computer being programmable to schedule when medication is required to be taken by the patient;
g) said computer being operable to send a signal to the personal notification device so that the notification device will provide an alarm to the patient;
h) said computer being in communication with the dispensing device;
i) said dispensing device including a proximity sensor for determining when the personal notification device is near the dispensing device; and,
j) said computer further being programmable to cause the dispensing device to dispense medication when the personal notification device is in the proximity of the dispensing device.

8. The system as set forth in claim 7, wherein:
a) the personal notification device includes a wristband.

9. The system as set forth in claim 7, wherein:
a) the personal notification device is capable of sending and receiving a wireless signal and is battery operated.

10. The system as set forth in claim 7, wherein:
a) the computer includes software that sets a schedule for dispensing medication, the schedule including frequency and amount.

11. The system as set forth in claim 7, wherein:
a) the computer is connected to a web based server.

12. The system as set forth in claim 7, wherein:
a) said cartridge being electronically controlled by a computer system configured to receive a signal and activate the cartridge to dispense a tablet;
b) said cartridge having a tablet receiving space for receiving and retaining a plurality of tablets in a vertical stack;
c) said cartridge having a base with a tablet dispensing opening to allow for at least one tablet to be dispensed from the base of the cartridge; and,
d) a moveable ram associated with the cartridge to engage a single tablet in the vertical stack and expel the single tablet from the cartridge.

13. The system as set forth in claim 7, wherein:
a) said cartridge forms a vertically elongated box having four walls defining the tablet receiving space;
b) a first wall of said four walls having a first moveable plate adjacent thereto and extending substantially the length of the first wall and extending substantially the length of the first wall;
c) a second wall of said four walls extending perpendicularly to said first wall and having a second moveable plate adjacent thereto and extending substantially the length of the second wall;
d) said first moveable plate having an adjustment device connected thereto for moving the first moveable plate away from said first wall;
e) said second moveable plate having an adjustment device connected thereto for moving the second moveable plate away from said second wall;
f) whereby, the first and second moveable plates can be adjusted so that the tablet receiving space can conform to tablets having different shapes.

14. The system as set forth in claim 7, further comprising:
a) a plurality of cartridges.

15. The system as set forth in claim 14, wherein:
a) each of said plurality of cartridges can be configured to contain a different sized tablet than the other of said plurality of cartridges.

16. A method for dispensing medication to a patient using a computer controlled dispensing device, comprising the steps of:
a) programming a dispensing device to dispense medication to a patient according to a schedule having a predetermined frequency, time and amount;
b) retaining a plurality of units of medication in a dispensing device;
c) determining the proximity of a patient to the dispensing device; and,
d) dispensing at least one unit of medication to the patient according to the schedule when the patient is in the proximity of the dispensing device.

17. The method as set forth in claim 16, further comprising:
a) providing a notification signal to the patient when a scheduled medication time occurs.

18. The method as set forth in claim 16, further comprising:
a) dispensing a plurality of units of medication to the patient.

19. The method as set forth in claim 16, further comprising:
a) tracking the dispensing of medication to the patient to monitor patient compliance.

20. The method as set forth in claim 16, further comprising:
a) confirming the presence of the patient using a code.
